(19) United States
(12) Patent Application Publication
(10) Pub. No.: US 2004/0054118 A1
(43) Pub. Date: Mar. 18, 2004

(54) Gel coat composition

(76) Inventors: Andre Muller, Saint Louis (FR); Isabelle Frischinger, Riespach (FR)

Correspondence Address: PROSKAUER ROSE LLP, PATENT DEPARTMENT, 1585 BROADWAY, NEW YORK, NY, 10036-8299, US

(21) Appl. No.: 10/470,766

(22) PCT Filed: Jan. 12, 2002
(86) PCT No.: PCT/EP02/00239

(30) Foreign Application Priority Data
Jan. 29, 2001 (CH) 155/01

(51) Int. Cl. C08G 18/32; C08G 18/60; C08G 18/28; C08G 18/77

(52) U.S. Cl. 528/68; 528/73

(57) ABSTRACT

Composition comprising (a) an epoxyurethane, (b) an aliphatic or cycloaliphatic epoxy resin other than (a), and (c) a compound of formula (Ia) or (Ib), wherein A is an (n+1)-valent aliphatic or cycloaliphatic radical and n is an integer from 0 to 5, E is an (m+1)-valent aliphatic or cycloaliphatic radical and m is an integer from 0 to 3, X is —O—, —COO— or —CHR₄—, R₁ and R₂ are each independently of tae other hydrogen or methyl, R₃ is hydrogen, R₅ is a monovalent aliphatic or cycloaliphatic radical, or when X is —CHR₄—, R₃ and R₄ together form an ethylene group, yield cured products having high resistance to weathering and UV-resistance an are suitable especially as gel coats.

The present invention relates to epoxy resin compositions and to their use as gel coats.

Composite materials that are designed to have a smooth glossy surface and that are exposed to the action of wind and weather are frequently provided with curable polymer coatings, so-called gel coats.

Hitherto, unsaturated polyesters have predominantly been used for that purpose, for example the compounds proposed in JP-A 09-263692, or polyurethanes, such as the systems described in JP-A 11-021325.

On account of their brittleness and insufficient weather-resistance, epoxy resins have hitherto been regarded as being suitable for gel coat applications only under certain conditions.

It has now been found that specific epoxy resin compositions comprising polymercaptopolyamines as hardeners have excellent processing properties and yield cured products that are distinguished both by high resistance to weathering and by very good UV-resistance, and are accordingly suitable as gel coat compositions.

The present invention relates to a composition comprising

(a) an epoxyurethane,

(b) an aliphatic or cycloaliphatic epoxy resin other than (a), and

(c) a compound of formula Ia or Ib,

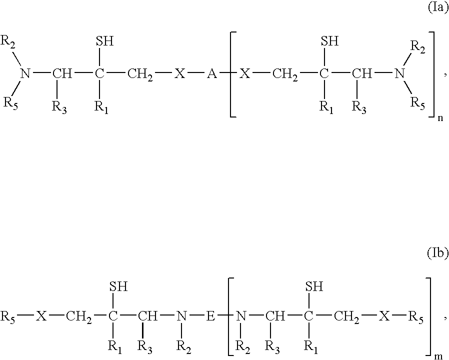

wherein A is an (n+1)-valent aliphatic or cycloaliphatc radical and n is an integer from 0 to 5,

E is an (m+1)-valent aliphatic or cycloaliphatic radical and m is an integer from 0 to 3,

X is —O—, —COO— or —CHR₄—,

R₁ and R₂ are each independently of the other hydrogen or methyl,

R₃ is hydrogen,

R₅ is a monovalent aliphatic or cycloaliphatic radical, or

when X=—CHR₄—, R₃ and R₄ together form an ethylene group.

The epoxyurethanes according to component (a) can be prepared by reacting any hydroxyl-group-containing polyepoxides with polyisocyanates, the polyepoxide being used in an excess such that all the isocyanate groups of the polyisocyanate are reacted.

The adduct of a hydroxyl-group-containing polyglycidyl compound and an aliphatic or cycloaliphatic polyisocyanate is preferably used as component (a).

Special preference is given to the adducts of trimethylolpropane diglycidyl ether, pentaerythritol triglycidyl ether and glycerol diglycidyl ether.

For the preparation of the epoxyurethanes, in principle any aliphatic or cycloaliphatic isocyanate having at least two isocyanate groups is suitable.

Examples thereof include hexane 1,6-diisocyanate, cyclohexane 1,2-diisocyanate, cyclohexane 1,3-diisocyanate, cyclohexane 1,4-diisocyanate, 4,4′-dicyclohexylmethane diisocyanate and isophorone diisocyanate.

Preference is given to the use of cyclohexane diisocyanate, 4,4′-dicyclohexylmethane diisocyanate and isophorone diisocyanate for the preparation of epoxyurethanes.

Suitable as component (b) are all known aliphatic and cycloaliphatic epoxy resins.

Examples of aliphatic epoxy resins include glycidyl ethers of acyclic alcohols, for example ethylene glycol, diethylene glycol, higher poly(oxyethylene) glycols, propane-1,2-diol, poly(oxypropylene) glycols, propane-1,3diol, butane-1,4-diol, poly(oxytetramethylene) glycols, pentane-1,5diol, hexane-1,6-diol, hexane-2,4,6-triol, glycerol, 1,1,1-trimethylolpropane, pentaerythritol and sorbitol.

In the context of the present invention, cycloaliphatic epoxy resins are either resins containing cycloalkeneoxide structures, for example bis(2,3-epoxycyclopentyl) ether, 2,3-epoxycyclopentyl glycidyl ether, 1,2-bis(2,3-epoxycyclopentyloxy)ethane or 3,4-epoxycyclohexylmethyl 3′,4′-epoxycyclohexanecarboxylate, or resins containing cycloalkane units and glycidyl groups, for example the diglycidyl ethers of 1,4-cyclohexanedimethanol, bis(4-hydroxycyclohexyl)methane and 2,2-bis(4-hydroxycyclohexyl)propane or the diglycidyl esters of tetrahydrophthalic acid, 4-methyltetrahydrophthalic acid, hexahydrophthalic acid or 4-methylhexahydrophthalic acid.

As component (b), preference is given to 3,4-epoxycyclohexylmethyl 3′,4′-epoxycyclohexanecarboxylate, 1,4-bis(hydroxymethyl)cyclohexane diglycidyl ether, hexahydrophthalic acid diglycidyl ester, trimethylolpropane triglycidyl ether and pentaerythritol tetraglycidyl ether.

In formula Ia, A can in principle be any mono- to hexa-valent radical of an epoxide. Preference is given to bi-, tri- and tetra-valent radicals.

Examples of aliphatic radicals include ethylene, propylene, tetramethylene, hexamethylene, poly(oxyethylene), poly(oxypropylene), poly(oxytetramethylene), 2-methyl-1,5-pentanediyl, 2,2,4-trimethyl-1,6-hexanediyl, 2,4,4-trimethyl-1,6-hexanediyl and the radicals of aliphatic alcohols after removal of the OH groups, for example the radicals of trimethylolpropane, of pentaerythritol and of dipentaerythritol.

Cycloaliphatic radicals include, for example, cyclopentyl, cyclohexyl, 1,3-cyclopentylene, 4-methyl-1,3-cyclopentylene, 1,2-cyclohexylene, 1,3-cyclohexylene, 1,4-cyclohexylene, 4-methyl-1,3-cyclohexylene, 2,5-norbornanediyl, 2,6-norbornanediyl, 7,7-dimethyl-2,5-norbornanediyl, 7,7-dimethyl-2,6-norbornanediyl, cyclohexane-1,3-dimethylene, cyclohexane-1,4dimethylene, 3-methylene-3,5,5-trimethylcyclohexylene (isophorone), norbornane-2,5-dimethylene, norbornane-2,6-dimethylene, 7,7-dimethylnorbornane-2,5-dimethylene and 7,7-dimethyinorbornane-2,6-dimethylene and the radicals of cycloaliphatic alcohols after removal of the OH groups, for example the radicals of hydrogenated bisphenol A and hydrogenated bisphenol F.

Preference is given to compounds of formula Ia wherein X is —O— and A is a bivalent radical of a cycloaliphatic diol, the bi- to tetra-valent radical of an isocyanate/polyol adduct or the tri- to hexa-valent radical of a tri- to hexa-functional aliphatic polyol.

Special preference is given to compounds of formula Ia wherein X is —O— and A is a bivalent radical of formula

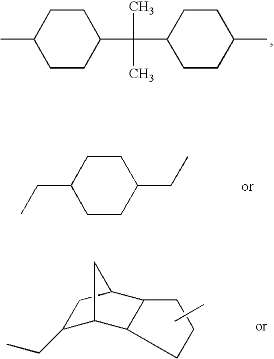

a trivalent radical of formula

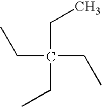

or the tetravalent radical of formula

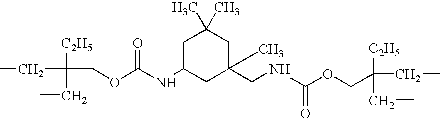

In formulae Ia and Ib, R₅ is preferably C₁-C₂₀alkyl or C₅-C₁₂cycloalkyl each unsubstituted or substituted by one or more amino groups, hydroxyl groups, C₁-C₈alkoxy groups or halogen atoms.

Suitable alkyl groups as R₅ are, for example, methyl, ethyl, isopropyl, n-propyl, n-butyl, isobutyl, sec-butyl, tert-butyl and the various isomeric pentyl, hexyl, heptyl, octyl, nonyl, decyl, undecyl, dodecyl, tridecyl, tetradecyl, pentadecyl, hexadecyl, heptadecyl and octadecyl groups.

Cycloalkyl is preferably C₅-C₈cycloalkyl, especially C₅- or C₆-cycloalkyl. Examples thereof include cyclopentyl, methylcyclopentyl, cyclohexyl, cycloheptyl and cyclooctyl.

Preference is given to compounds of formulae Ia and Ib wherein R₅ is C₂-C₁₀alkyl, C₂-C₁₀-aminoalkyl, cyclohexyl or a radical of formula H₂N-Z-CH₂-—NH—, wherein Z is a bivalent cycloaliphatic radical or a radical of formula —(CH₂CH₂NH)ₖ—CH₂—, wherein k is 2 or 3.

Suitable radicals Z are, for example, the bivalent radicals mentioned above for A.

Special preference is given to compounds of formulae Ia and Ib wherein R₁ is n-butyl, n-octyl, cyclohexyl, 2-aminoethyl, 4-(aminomethyl)pentyl, 5-amino-2-methylpentyl, 3-dimethylaminopropyl, 3-methylaminopropyl, 4-aminocyclohexyl or a radical of formula —CH₂CH₂NHCH₂CH₂NH₂,

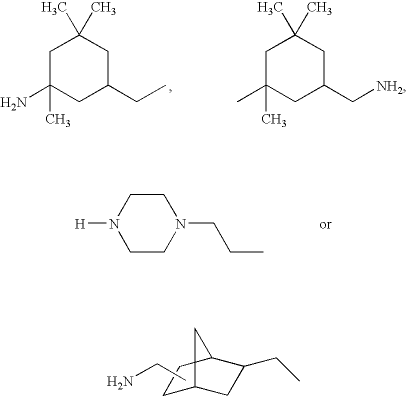

Preference is also given to compounds of formula Ia or Ib wherein X is O— and R₁ and R₃ are hydrogen.

The compounds of formula Ia can be prepared according to known methods from the epoxy compounds of formula IIa

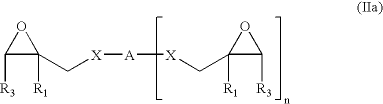

wherein A, X, R₁, R₃ and n are as defined above.

In such methods, the epoxy compound of formula IIa is converted, in a first reaction step, by reaction with thiourea or with an alkali metal thiocyanate or ammonium thiocyanate, preferably potassium thiocyanate, into the episulfide of formula IIIa

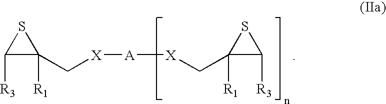

In that process, thiourea or thiocyanate is advantageously used in such an amount that there are from 0.8 to 1.2 equivalents of sulfur per epoxy equivalent.

The reaction can be carried out in aprotic or protic organic solvents or in mixtures thereof. Preference is given to alcohols, such as methanol or ethanol, and to aromatic hydrocarbons, such as toluene and xylene. The addition of co-solvents, such as ethers or carboxylic acids, can speed up the reaction.

The reaction can be carried out at room temperature or at elevated temperature; the preferred reaction temperature is from 60 to 100° C.

The episulfide of formula IIIa can be isolated by separating off the by-products by means of filtration, extraction, phase separation and subsequent concentration by evaporation of the solvent.

It is also possible, however, for the episulfide of formula IIIa to be processed further directly in the form of the crude product in solution without separating off the by-products.

The episulfide of formula IIIa is then dissolved in an aprotic or protic organic solvent and reacted under an inert gas (argon or nitrogen) with the amine R₅—NH—R₂. The amount of the amine is preferably so selected that there are from 1 to 10 NH groups per episulfide group. Preferred solvents are alcohols (e.g. methanol, ethanol, tert-butanol) and aromatic hydrocarbons, such as toluene or xylene.

The amine R₁—NH₂ is also preferably used in the form of a solution in one of the above-mentioned solvents.

The reaction is advantageously carried out at elevated temperature, preferably at from 40° C. to 120° C.

The compounds of formula Ia can be isolated by distilling off the solvent under reduced pressure. The excess amine R₅—NH—R₂ can also be removed by distillation at elevated temperature. In a particular embodiment of the invention, the amine R₅—NH—R₂ is used as a co-hardener, in which case, separation of the product of formula Ia and the amine R₅—NH—R₂ is not necessary; rather, the reaction product can be used as a hardener for epoxy resins without further working-up. That procedure is recommended especially when using di- or poly-amines.

The compounds of formula Ib can be prepared analogously from the corresponding epoxy compounds of formula IIb,

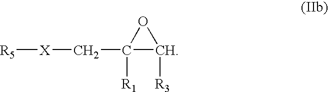

wherein X, R₁, R₃ and R₅ are as defined above.

Episulfides can be synthesised, for example, also from the corresponding epoxides by reaction with triphenylphosphine sulfide.

Moreover, episulfides can be prepared according to known methods directly from the corresponding alkenes, for example by reaction with m-chloroperbenzoic acid and subsequent reaction with thiourea in the presence of H₂SO₄, by reaction with propylene sulfide in the presence of rhodium catalysts and by reaction with (diethoxyphosphoryl)sulfenyl chloride, (diethoxythiophosphoryl)sulfenyl bromide, thiobenzophenone S-oxide or bis(trimethylsilyl) sulfide.

The polymercaptopolyamines according to the invention can be used advantageously in combination with other epoxy hardeners, especially with aliphatic or cycloaliphatic amine hardeners.

The invention accordingly relates also to a composition comprising

(a) an epoxyurethane,

(b) an aliphatic or cycloaliphatic epoxy resin other than (a),

(c) a compound of formula Ia or Ib, and

(d) an aliphatic or cycloaliphatic polyamine.

Examples of suitable polyamines (d) are aliphatic and cycloaliphatic amines, such as n-octylamine, propane-1,3-diamine, 2,2-dimethyl-1,3-propanediamine (neopentanediamine), hexamethylenediamine, diethylenetriamine, bis(3-aminopropyl)amine, N, N-bis(3-aminopropyl)methylamine, triethylenetetramine, tetraethylenepentamine, pentaethylenehexamine, 2,2,4-trimethylhexane-1,6diamine, 1,2- and 1,4-diaminocyclohexane, bis(4-aminocyclohexyl)methane, bis(4-amino-3-methylcyclohexyl)methane. 2,2-bis(4-aminocyclohexyl)propane and 3-aminomethyl-3,5,5-trimethylcyclohexylamine (isophoronediamine) and polyaminoamides, for example those from aliphatic polyamines and dimerised or trimerised fatty acids. Suitable amines (d) are also the polyoxyalkyleneamines known as Jeffamines®, made by Texaco, for example Jeffamine® EDR148, D230, D400 or T403.

Further suitable polyamines (d) are 1,14-diamino-4,11-dioxatetradecane, dipropylenetriamine, 2-methyl-1,5-pentanediamine, N,N′-dicyclohexyl-1,6-hexanediamine, N,N′-dimethyl-1,3-diaminopropane, N,N′-diethyl-1,3-diaminopropane, N,N-dimethyl-1,3-diaminopropane, secondary polyoxypropylene-di- and -tri-amines, 2,5-diamino-2,5-dimethylhexane, bis(aminomethyl)tricyclo-pentadiene, 2,6-bis(aminomethyl)norbornane, 1,8-diamino-p-methane, bis(4-amino-3,5-dimethylcyclohexyl)methane, 1,3-bis(aminomethyl)cyclohexane and dipentylamine.

As component (d) of the substance mixtures according to the invention, preference is given to cycloaliphatic amines, especially isophoronediamine.

The proportions of components (a), (b), (c) and optionally (d) in the compositions according to the invention can vary within wide ranges. The optimum proportions are dependent inter alia upon the type of amine and can be determined readily by the person skilled in the art.

Preference is given to compositions according to the invention wherein the ratio by weight of components (a): (b) is from 10:1 to 2:1, especially from 5:1 to 3:1.

Components (c) and optionally (d) are preferably used in such amounts that the sum of the amine and mercaptan equivalents is from 0.5 to 2.0, especially from 0.8 to 1.5 and preferably from 0.9 to 1.2 equivalents, based on one epoxy equivalent.

The compositions according to the invention may optionally comprise accelerators, for example tertiary amines, imidazoles or Ca(NO₃)₂.2H₂O.

The curable mixtures may also comprise tougheners, for example core/shell polymers or the elastomers or elastomer-containing graft polymers known to the person skilled in the art as “rubber tougheners”.

Suitable tougheners are described, for example, in EP-A449 776.

The curable mixtures may also comprise fillers, for example glass powder, glass beads, semi-metal oxides and metal oxides, for example SiO₂ (Aerosils, quartz, quartz powder, fused silica powder), corundum and titanium oxide, semi-metal nitrides and metal nitrides, for example silicon nitride, boron nitride and aluminium nitride, semi-metal carbides and metal carbides (SiC), metal carbonates (dolomite, chalk, CaCO₃), metal sulfates (barytes, gypsum), ground minerals and natural or synthetic minerals chiefly from the silicate series, for example zeolites (especially molecular sieves), talcum, mica, kaolin, wollastonite, bentonite and others.

The amount of fillers in the compositions according to the invention is preferably in the range of from 5 to 30% by weight, based on the total composition.

In addition to the above-mentioned additives, the curable mixtures may comprise further customary additives, for example solvents, antioxidants, light stabilisers, plasticisers, dyes, pigments, thixotropic agents, toughness improvers, tackifiers, antifoams, antistatics, lubricants and mould-release aids.

The curing of the epoxy resin compositions according to the invention is effected in a manner customary in epoxy resin technology, as described, for example, in “Handbook of Epoxy Resins”, 1967, by H. Lee and K. Neville.

The curable mixtures have only a slight tendency to carbonatisation (becoming cloudy). The cured products are distinguished by surprisingly high resistance to chemicals, resistance to weathering and UV-resistance.

The invention relates also to the crosslinked products obtainable by curing a composition according to the invention.

The compositions according to the invention are excellent for use as gel coats.

### EXAMPLES

I. Preparation of the Compounds of formula I

a) General Procedure for the Preparation of Polyepisulfides:

The polyepoxide of formula II is dissolved in from 0.5 to 5 times the amount of solvent and stirred, under nitrogen, with thiourea or alkali metal thiocyanate or ammonium thiocyanate (0.8-1.2 equivalents of sulfur per epoxy equivalent) at 60-100° C. until the epoxy content has fallen to virtually zero.

After separating out the by-products by filtration, extraction or phase separation, the polyepisulfide is isolated by concentration by evaporation of the solvent.

b) General Procedure for the Preparation of Polymercaptopolyamines:

The polyepisulfide is dissolved in from 0.5 to 5 times the amount of solvent and, under nitrogen with vigorous stirring, is combined with the amine which has also been dissolved in from 0.5 to 5 times the amount of solvent. The amount of amine is so selected that there are from 1 to 10 NH₂ groups per episulfide group. After stirring for from 0.2 to 3 hours at 60-100° C., the solvent is distilled off under reduced pressure. In order to isolate the polymercaptopolyamine of formula I, the excess amine reagent is removed by distillation in vacuo at elevated temperature.

An embodiment of the invention dispenses with removal of the excess amine and uses the mixture of the amine R₁—NH₂ and the polymercaptopolyamine of formula I as hardener for epoxy resins.

In accordance with the procedure given above, there is prepared from n-butylamine and 1,4-bis(hydroxymethyl)cyclohexane diglycidyl ether the thioalkylamine of formula Ia1

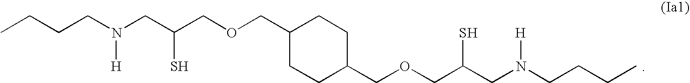

In the following Examples, the isophorone diisocyanate adduct of trimethylolpropane diglycidyl ether (epoxyurethane 1) is used as component (a):

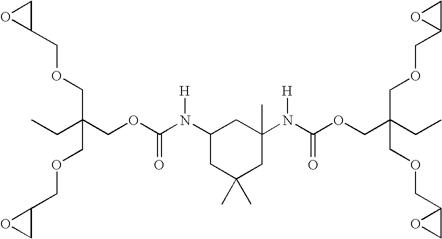

### APPLICATION EXAMPLES

II.1 A Gel Coat Composition is Prepared by Mixing the Constituents Given in Table 1.

| | |
|---|---|
| TMPTGE: | trimethylolpropane triglycidyl ether |
| AW 1136 SP: | carbon black Printex V AW 1136 SP-black pigment |
| | (Degussa) |
| HA 1681 | Coathylen ® special fine powders HA 1681-thixotropic |
| | agents, low density polyethylene (Herberts Polymer |
| | Powders SA) |
| Aerosil H18: | SiO₂ thixotropic agent (Wacker Chemie) |
| IPD: | isophoronediamine |
| TDMAP: | 2,4,6-tris[(3-dimethylaminopropyl)aminomethyl]phenol |

The gel coat mixture is applied by means of a brush or roller to a negative mould that has been pretreated with parting agent. The formulation is then pregelled for from 30 to 80 minutes at a temperature of about from 23° C. to 40° C. A 2 to 50 mm laminate consisting of woven glass fibre and a resin/hardener mixture is then applied and full curing is carried out under pressure in a vacuum bag at from 60° to 90° C. for from 4 to 10 hours. The fully cured moulding is cooled and removed from the mould. Test samples are cut therefrom.

DSC Measurement:

The glass transition temperature T_{g} of the gel coat is measured, after full curing, by differential scanning calorimetry (DSC) (6 hours/80° C.); 2^{nd} scan: T_{g} onset

Measurement of Drying Time:

Measurement of the drying time of coatings, with differentiation between the successive drying stages using a drying time measuring device from BYK Gardner

TABLE 1

| Example | 1 |
|---|---|
| Resin component: | |
| epoxyurethane 1 [g] | 80 |
| TMPTGE [g] | 20 |
| AW 1136 SP [g] | 2 |
| HA 1681 [g] | 1 |
| TiO₂ [g] | 6 |
| Aerosil H18 [g] | 1 |
| Hardener component | |
| thioalkylamine Ia1 [g] | 52 |
| IPD [g] | 6 |
| TDMAP [g] | 2 |
| T_{g onset}/T_{g} (DSC) [° C.] | 48/56 |
| Drying time | 35-85 mm |

What is claimed is:

1. A composition comprising
(a) an epoxyurethane,
(b) an aliphatic or cycloaliphatic epoxy resin other than (a), and
(c) a compound of formula Ia or Ib, 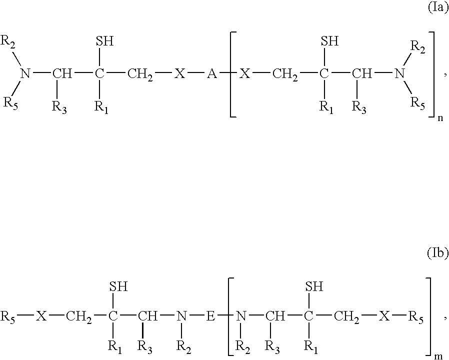
wherein A is an (n+1)-valent aliphatic or cycloaliphatic radical and n is an integer from 0 to 5,
E is an (m+1)-valent aliphatic or cycloaliphatic radical and m is an integer from 0 to 3,
X is —O—, —COO— or —CHR₄—,
R₁ and R₂ are each independently of the other hydrogen or methyl,
R₃ is hydrogen,
R₅ is a monovalent aliphatic or cycloaliphatic radical, or
when X is —CHR₄—, R₃ and R₄ together form an ethylene group.

2. A composition according to claim 1 comprising as component (a) the adduct of a hydroxyl-group-containing polyglycidyl compound and an aliphatic or cycloaliphatic polyisocyanate.

3. A composition according to claim 2, wherein the hydroxyl-group-containing polyglycidyl compound is selected from trimethylolpropane diglycidyl ether, pentaerythritol triglycidyl ether and glycerol diglycidyl ether.

4. A composition according to claim 2, wherein the aliphatic or cycloaliphatic polyisocyanate is selected from cyclohexane diisocyanate, 4,4′-dicyclohexylmethane diisocyanate and isophorone diisocyanate.

5. A composition according to claim 1 comprising as component (b) 3,4-epoxycyclohexylmethyl 3′,4′-epoxycyclohexanecarboxylate, 1,4-bis(hydroxymethyl)cyclohexane diglycidyl ether, hexahydrophthalic acid diglycidyl ester, trimethylolpropane triglycidyl ether or pentaerythritol tetraglycidyl ether.

6. A composition according to claim 1 comprising as component (c) a compound of formula Ia, wherein X is —O— and A is a bivalent radical of formula 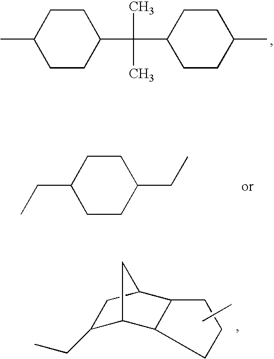
radical of formula 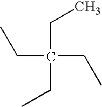
or the tetravalent radical of formula

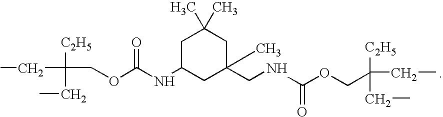

7. A composition according to claim 1 comprising as component (c) a compound of formula Ia wherein R₁ is n-butyl, n-octyl, cyclohexyl, 2-aminoethyl, 4-(aminomethyl)pentyl, 5-amino-2-methylpentyl, 3-dimethylaminopropyl, 3-methylaminopropyl, 4-aminocyclohexyl or a radical of formula —CH₂CH₂NHCH₂CH₂NH₂,

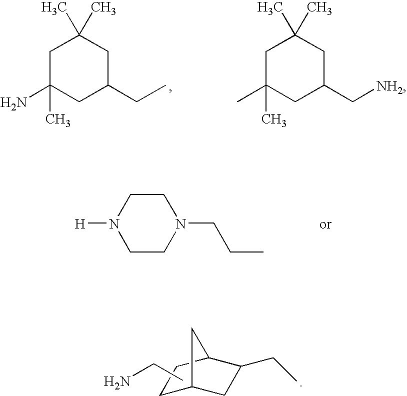

8. A composition according to claim 1 comprising in addition
(d) an aliphatic or cycloaliphatic polyamine.

9. A composition according to claim 1, wherein the ratio by weight of components (a): (b) is from 10:1 to 2:1.

10. A composition according to claim 1 comprising components (c) and optionally (d) in such amounts that the sum of the amine and mercaptan equivalents is from 0.5 to 2.0 equivalents, based on one epoxy equivalent.

11. A crosslinked product obtainable by curing a composition according to claim 1.

12. Use of a composition according to claim 1 as a gel coat.
